(19) United States
(12) Patent Application Publication
(10) Pub. No.: US 2006/0123807 A1
(43) Pub. Date: Jun. 15, 2006

(54) Apparatus and method for monitoring and displaying power usage

(76) Inventors: C. Bret Sullivan, Fresno, CA (US); C. Bart Sullivan, Benicia, CA (US)

Correspondence Address: C. Bart Sullivan, 1543 Sherman Dr., Benicia, CA, 94510, US

(21) Appl. No.: 11/012,040

(22) Filed: Dec. 14, 2004

(51) Int. Cl. G01K 13/00; F25D 21/06

(52) U.S. Cl. 62/129

(57) ABSTRACT

A method and system to monitor and determine energy consumption and energy efficiency of devices that use electrical and/or gas power is described. In one embodiment, a power monitoring system is configured to monitor electrical and/or gas power consumption of devices such as refrigerators, air-conditioners, washers, dryers, hot tubs, etc. Power consumption of the device is processed by the power monitoring system to determine the amount of power the device is consuming and the device's energy efficiency. In one embodiment, the power monitoring system transmits data associated with the device's power consumption, such as power efficiency, power cost, power usage, etc., to the device user and/or to a power supplier such as a utility company supplying the gas and/or electricity to the device. In one configuration, when the power efficiency of the device exceeds a predefined threshold, the user and/or power supplier is notified. The power monitoring system may be configured to be integral with and/or attached to the device being measured. The power monitoring system may provide an output on a display apparatus associated with the power monitoring system attached to the device being monitored and/or the output may be part of a graphics display on a computer monitor, for example.

### BACKGROUND OF THE INVENTION

1. Field of the Invention

Embodiments of the present invention generally relate to electrical power measurement. More specifically, the present invention relates to monitoring of gas and/or electrical power usage of apparatuses such as household appliances.

2. Description of the Related Art

Generally, electrical power meters placed in series with an incoming power line and/or gas power meters placed inline with gas supplies measure power usage of homes and businesses. For example, a home power usage may be determined by a utility company placing a meter in line with an incoming power line or gas supply. Such a conventional meter measures the amount of power and/or gas that is consumed by the home or business. In some cases, a power meter attendant reads the power usage and based on the power usage, the utility company supplying the power provides an electrical bill and/or gas bill to a user thereof reflecting such power usage readings. Generally, such reading corresponds to a given time period between power meter readings, such as a month.

Power usage from a common power source is directly associated with power consumption by one or more apparatuses connected to such a power source. Power usage generally increases and decrease in response to the number and type of devices connected to the power source and consuming power. Such consumption therefore is directly related to a user's use of appliances that consume electrical and/or gas power. For example, in the winter a user may require the use of a heater to warm a home, or an air-conditioner in the summer to cool their home.

Often, an appliance such as an air-conditioner is set in an automatic mode of operation such that when one or more operational thresholds are crossed, such an appliance will automatically operate. For example, if a user of an air-conditioner has set the air-conditioner to keep a home at 68° Fahrenheit (F.), and the air-conditioning system detects a temperature of 79° F., such an air-conditioner will automatically operate to bring the home temperature to 68° F. Such automatic operation is common with many appliances such as refrigerators, televisions, video recording devices, alarm systems, sprinkler systems, etc. As the device's automatic operation is generally based on one or more user programmed conditions, environmental conditions, operating conditions, etc., operation and power consumption of such electronic appliances is generally random.

Generally, power consumption is measured as an aggregate average of all of the devices commonly powered. Therefore, a user thereof and a utility company supplying such power generally do not notice degradation in power efficiency for such electronic devices operating within a manufactures specified operating parameters. In addition, as device operation is generally random in nature, such a user thereof cannot readily discriminate between a more severe degradation in power efficiency and additional use of one or more devices.

Even though over time an appliance may be degrading in power efficiency, it still may be operating within acceptable manufacture's operational specifications and operating satisfactorily to a user thereof. For example, a refrigerator may operate more efficiently when brand new than when older due to mechanical wear and environmental contamination of external parts such as external heat exchange systems. While such older refrigerator may become less energy efficient, such an older refrigerator may be operating within its manufacturer's specifications and therefore adequately keep food and beverages stored at a desired temperature and climate to the satisfaction of the user.

Unfortunately, as such a refrigerator's power usage is an aggregate of other commonly powered appliances' power usage, and is averaged as part of an overall power usage of such other appliances', a user thereof may not notice an increase in cost to operate such less efficient refrigerator. For example, an additional use of a large power consumption appliance such as an air conditioner may be sufficient to mask a change in the cost of such a less power efficient refrigerator.

Unfortunately, if such a refrigerator is not maintained, such an increase in cost of operation may result in a user unnecessarily paying hundreds and possibly thousands of dollars over the life of such a refrigerator. Further, a utility company supplying power to such a less efficient refrigerator would need to generate additional power to compensate for such a loss of efficiency which generally increases the cost of power generation.

Therefore, what is needed is a method and apparatus to configured to monitor individual power consumption of devices and provide a user thereof and/or third parties such as utility companies, information associated with such individual power consumption.

### SUMMARY OF THE INVENTION

An embodiment of the present invention is an apparatus which includes a power sensor configured to monitor power consumed by a device, a data storage device configured to store data associated with the power consumed, and an output device configured to output data associated with the power consumed. The apparatus also includes a processor, which when executing a power monitoring program, is configured to generate power consumption values associated with the power consumed, determine if the power consumption values have exceeded a predetermined power consumption threshold, and output power consumption data indicative of any power consumption values that have exceeded the predetermined power consumption threshold. The processor is also configured to generate power efficiency values associated with the power consumed, determine if any of the power efficiency values have exceeded a predetermined power efficiency threshold, output power efficiency data indicative of the power efficiency values that have exceeded the predetermined power efficiency threshold, generate monetary cost values associated with the power consumed, determine if any of the monetary cost values have exceeded a predetermined monetary cost threshold, and provide monetary cost data indicative of any monetary cost values that have exceeded the predetermined monetary cost threshold.

Another embodiment of the present invention is a system configured to monitor power consumption of a device. The system includes a means for monitoring power consumption by the device and a means for processing the power consumption. The means for processing the power consumption is configured to analyze the power consumption of the device, determine if the power consumption has exceeded a predefined range of power consumption, determine from the power consumption a power efficiency of the device and determine if the power efficiency has exceed a predefined efficiency range associated with the device, and output data associated the power consumption and the power efficiency to a user thereof.

Another embodiment of the present invention is a method to measure the power consumption of an apparatus and provide data associated with the power consumption to a user thereof. The method includes measuring an overall power consumption of the apparatus, determining if the apparatus is operating within a predefined range of the overall power consumption. If the overall power consumption of the apparatus exceeds a predefined range for the overall power consumption then outputting overall power consumption error data indicative thereof. The method further includes determining if the apparatus is operating within a predefined power efficiency range. If the power efficiency of the apparatus exceeds the predefined power efficiency range then outputting power efficiency error data indicative thereof. The method includes determining a power efficiency degradation rate of the apparatus, determining a time value from the power efficiency degradation rate where the apparatus will exceed the predefined power efficiency range, and determining a monetary cost of the power consumption. The method further includes outputting at least one of the overall power consumption, the predefined power efficiency range, the power efficiency degradation rate, the time value, and the monetary cost to the user.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the accompanying drawings in which:

FIG. 1 is a high-level illustration of one embodiment of a power monitoring system in accordance with embodiments of the invention.

FIG. 2 is a high-level illustration of one embodiment of a power monitoring system in accordance with embodiments of the invention.

FIG. 3 is a high-level illustration of one embodiment of a power usage display in accordance with embodiments of the invention.

FIG. 4 is a high-level schematic of one embodiment of a power monitoring system in accordance with embodiments of the invention.

FIG. 5 is a high-level schematic of one embodiment of a power sensor apparatus in accordance with embodiments of the invention.

FIG. 6 is a high-level schematic of one embodiment of a power sensor apparatus in accordance with embodiments of the invention.

FIG. 7 is a high-level flow diagram of one embodiment of a method to monitor power usage in accordance with embodiments of the invention.

FIG. 8 is a high-level flow diagram of one embodiment of a method to monitor power usage in accordance with embodiments of the invention.

FIG. 9 is a high-level schematic of one embodiment of a gas sensor apparatus in accordance with embodiments of the invention.

### DETAILED DESCRIPTION OF THE PREFERRED EMBODIMENT

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Embodiments of the present invention are described in terms of wireless communication systems such as defined in IEEE 802.11, and networks such as Wireless Local Area Network (WLAN), Wireless Wide Area Networks (WWAN), and other networks utilizing data packet communication such as the Internet. However, It is understood the present invention is not limited to any particular communication system or network environment.

As will be described below, embodiments of the present invention pertain to specific method steps implementable on computer systems. In one embodiment, the invention may be implemented as a computer program-product for use with a computer system. The programs defining the functions of at least one embodiment can be provided to a computer via a variety of computer-readable media (i.e., signal-bearing medium), which include but are not limited to, (i) information permanently stored on non-writable storage media (e.g. read-only memory devices within a computer such as read only CD-ROM disks readable by a CD-ROM or DVD drive; (ii) alterable information stored on a writable storage media (e.g. floppy disks within diskette drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions of the invention, represent alternative embodiments of the invention. It may also be noted that portions of the product program may be developed and implemented independently, but when combined together are embodiments of the invention.

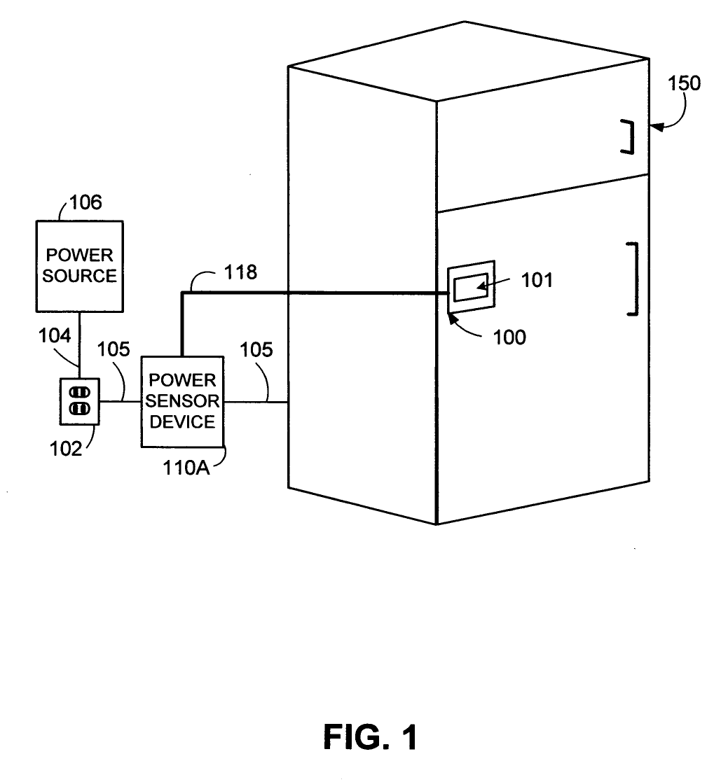

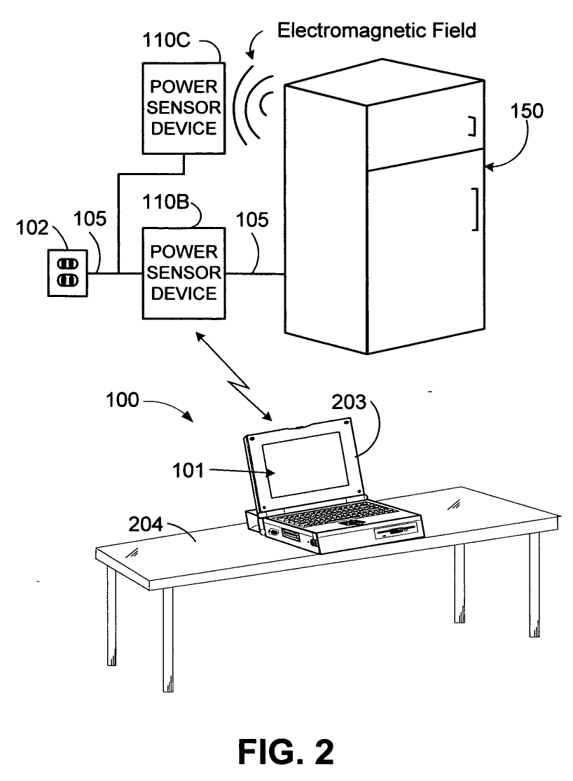

FIG. 1 and FIG. 2 are high-level illustrations of one embodiment of a power monitoring system 100 in accordance with embodiments of the invention. Referring to FIG. 1, illustratively, an apparatus 150 (e.g., a refrigerator appliance) is electrically coupled to a power source receptacle 102 though a power sensor 110A via power connection 105. Power sensor 110A is configured to detect electrical power (power) consumed by apparatus 150 and transmit data to power monitoring system 100 via data signal 118. For example, power sensor 110A may be electrically connected between a refrigerator (e.g., apparatus 150) and a wall power outlet (e.g., receptacle 102). Power sensor 110A may be configured to measure power consumption of such refrigerator apparatus 150 and transmit power consumption data to power monitoring system 100 for processing. Power sensor 110A may be configured to measure and process such power consumption data and provide a plurality of data signals associated therewith, such as analog and digital output data signals, via signal bus 118 to power monitoring system 100. Power monitoring system 100 may include a display 101 to display data associated with power consumption of apparatus 150. Power monitoring system 100 may be a stand alone system or configured integral to apparatus 150. While power monitoring system 100 is shown separate from power sensor 110A, it is contemplated that power monitoring system 100 and power sensor 110A may be integrated into a common device.

In one configuration, power monitoring system 100 may also be configured as a stand alone device configured to be attached to virtually any surface using fastening means such as magnetic, adhesive, and fasteners such as screws, bolts, rivets, and the like. For example, power monitoring system 100 may be configured into an apparatus having a magnetic or adhesive backing configured to attach power monitoring system 100 to apparatus 150.

Referring to FIG. 2, illustratively, an apparatus 150 is electrically coupled to a power source receptacle 102 though a power sensor 110B via power connection 105. Power sensor 110B is configured to detect electrical power (power) consumed by apparatus 150 and wirelessly transmit data to power monitoring system 100 which may be integrated into a data processing system 203 such as a computer placed for example on a table top 204.

In one configuration, power sensor 110B may be electrically coupled between an apparatus 150 and a power source (e.g., receptacle 102). Power sensor 110B may be configured to measure power consumption of such apparatus 150 and wirelessly transmit electrical power data to data processing system 203 configured as a power monitoring system 100 for processing power consumption data. In one embodiment, data processing system 203 includes a power data display 101 to display data associated with power consumption and configurations of apparatus 150.

In one embodiment, power monitoring system 100 may include a power sensor 110C. Power sensor 110C is configured to monitor the electromagnetic fields (EMF) of the apparatus 150. The power monitoring system 100 may be configured to correlate the EMF to the amount of power that is consumed by the apparatus 150. For example, at full energy efficiency when the apparatus 150 is new, the EMF may be measured by power sensor 110C at a first efficiency level. If the apparatus 150 consumes more power, the power sensor 110C is configured to monitor an increase in the EMF due to the increase in power consumption.

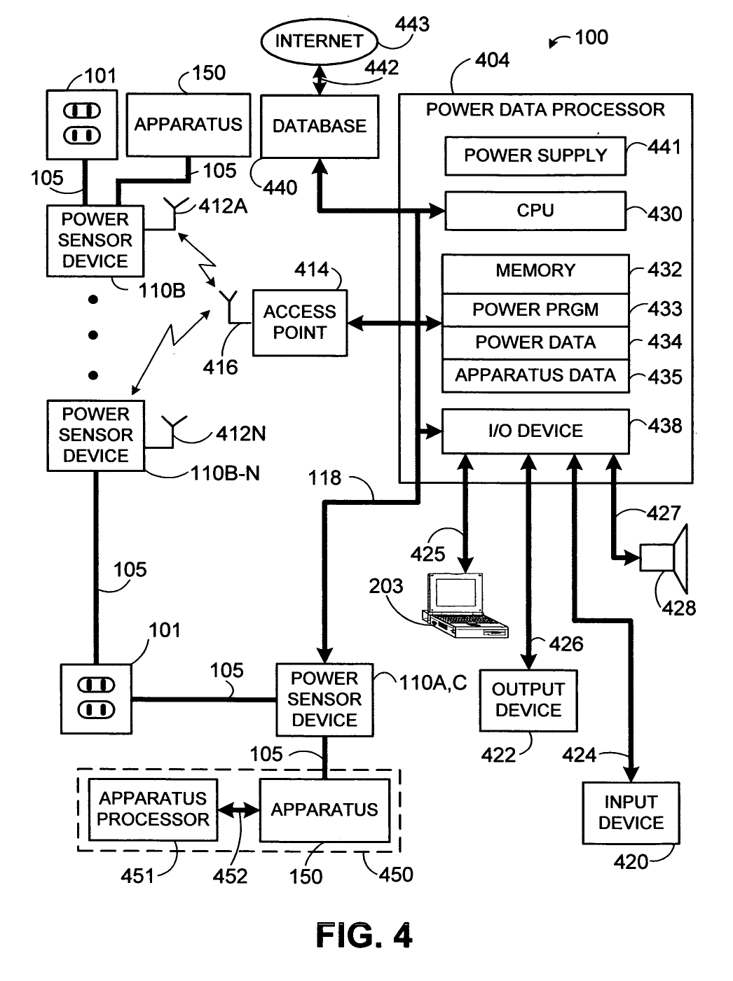

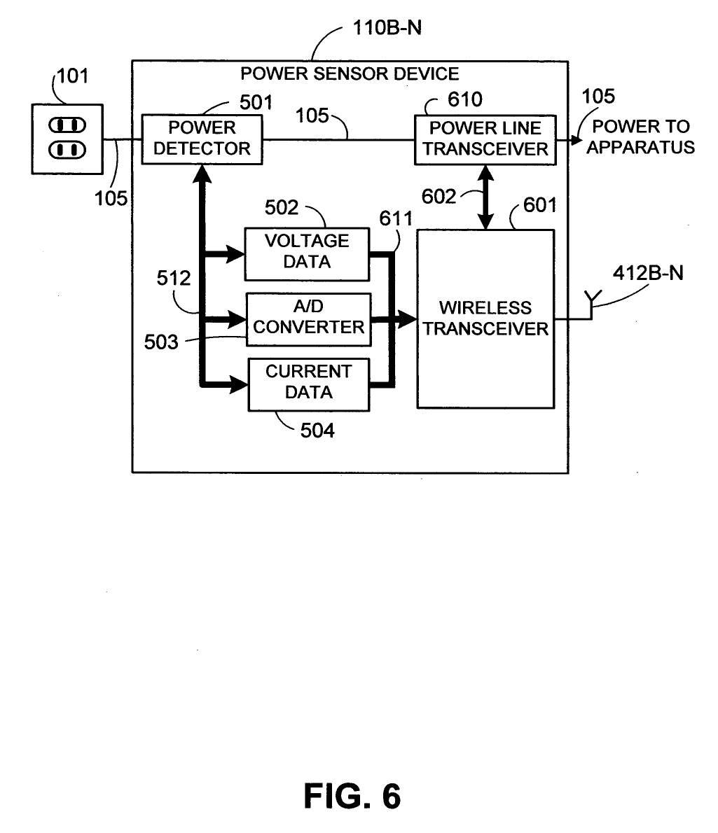

Similar to power sensors 110A and 110B, power sensor apparatus 110C is configured to communicate with the apparatus 150 and/or a third party (e.g., a utility company 106) via electrical connection 105 and power line 104 and/or wireless transceiver 601 (See FIGS. 1 and 6). Power sensor apparatus 110C cooperates with power data processor 404 (See FIG. 4) to determine the actual power consumed by the apparatus 150 and the expected power consumed by the apparatus 150.

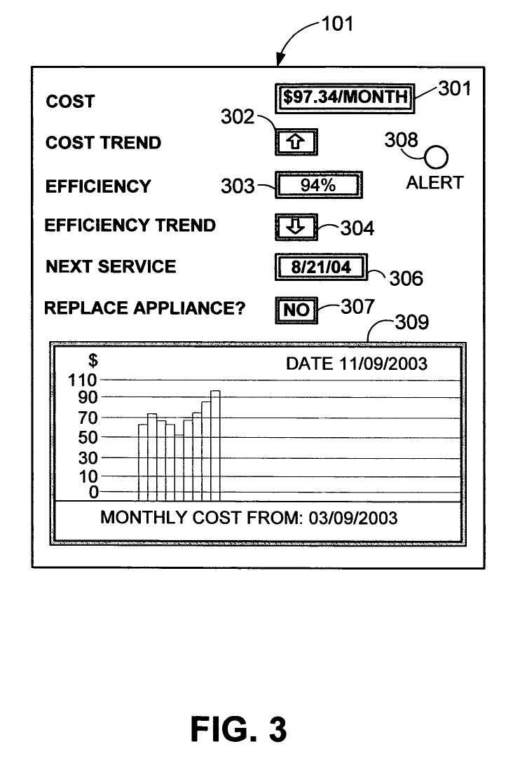

FIG. 3 is a high-level illustration of one embodiment of a power usage display 101 in accordance with embodiments of the invention. In one configuration, power data display 101 is configured to display one or more data values associated with power consumption of apparatus 150 (See FIG. 1). Power data display 101 may be configured to display cost of power consumption, a trend of power consumption, an efficiency rating, and the like, over one or more predefined time periods. Power data display 101 may also be configured to display other data associated with an apparatus 150 such as service date, serial number, model number, and the like. Power data display 101 may also be configured to display other data associated with an apparatus 150 such as alerts to replace or service such apparatus 150 when an operating condition has been met such as a manufacture's recommended service period has expired.

For example, as illustrated in FIG. 3, power data display 101 provides a monetary cost to operate value 301. Such monetary cost to operate value 301 may be indicative of a time period such a monthly cost of operation as illustrated, and may be configured to display monetary cost values in a variety of denominations associated with a plurality of other operational periods such as bimonthly, semi annually, annual, and the like. Power data display 101 may provide a cost trend display 302. Cost trend display 302 may display a trend in cost of operation and may display a trend in a cost of power associated with a utility company's charge for power consumption. Power data display 101 may provide an efficiency rating display 303. Efficiency rating display 303 may display a power efficiency relative a given power efficiency. For example, consider the case where an apparatus 150 has a manufacturer efficiency rating of ninety percent energy efficient, power data display 101 may provide an efficiency rating display 303 indicative thereof and may be configured to display a difference between current efficiency and such manufacturer specified efficiency ratings. In one case, as described further below, power monitoring system 100 may search and retrieve a power efficiency rating from external sources such as one or more manufacturer of apparatus 150, internal and external databases, and the like, and use such retrieved efficiency ratings to compare current operation of apparatus 150 thereto. Power data display 101 may provide a service display 306. Service display 306 may display a time to service apparatus 150 relative one or more of manufacture's recommended service periods, efficiency trends, monthly costs, and other service related events, some of which are described herein. Power data display 101 may provide a replace apparatus display 307. Replace apparatus display 307 may display a time to replace apparatus 150 associated with one or more of a manufacture's recommended replacement period, efficiency trends, monthly costs, and the like, described herein.

Power data display 101 may include an alert display 108 configured to alert a user thereof of when data associated with power consumption has crossed one or more thresholds associated with such power consumption. Power data display 101 may include a graphical display 310 configured to display one or more graphical representations of data associated with power consumption of apparatus 150. For example, as illustrated in FIG. 3, graphical display 310 displays a cost or operation of an apparatus over several monthly periods. As illustrated, graphical display 310 provides a bar graph display of a monthly cost of operation from a starting date. Graphical display 310 may be used for other functions such as providing a menu display to allow a user thereof to configure view one or more menus, functions, settings, and the like, associated with such power monitoring system 100.

FIG. 4 is a high-level schematic of one embodiment of a power monitoring system 100 in accordance with embodiments of the invention. Power monitoring system 100 includes power data processor 404. Power data processor 404 may be powered by power supply 441. Power supply 441 may be virtually any type of power supply that may be used to advantage and may use internal and/or external power sources such as batteries, AC-DC converters, and the like. Power data processor 404 may be electrically coupled to one or more power sensors 110A via bus 118. Power data processor 404 may be electrically coupled to one or more power sensors 110B-N via wireless access point 114. Wireless access point 114 includes antenna 416 configured to wirelessly couple power sensor 110B and power sensor 110N to wireless access point 414 via a respective antenna 412A-412N coupled thereto as is known in the art. Power sensor 110N and antenna 412N are defined herein as an Nth number, i.e., a plurality of power sensor 110A-N and respective antennas 412A-N.

For clarity, wireless communication is described herein between power sensors 110B-N and power data processor 404, however it is contemplated that one or more power sensors 110B-N may be connected using other connection techniques as are known such, optical connections, and the like, to power data processor 404. In addition, power data processor 404 may communicate with one or more power sensors 110A and 110B-N using data communication techniques as are known such as Ethernet, USB, firewire (IEEE 1394), serial communication, parallel communication, infrared communication, and the like.

Herein, for clarity embodiments of the present invention are described in terms of an operator, however it is contemplated that an operator may be a user, a system administrator, third party user, a utility company, computer tracking system, and include virtually any personnel and machine capable of utilizing data processed by power monitoring system 100.

To receive external data from a user or operator, power data processor 404 may also be in communication with an input device 420 via signal 424. Input device 420 can be virtually any device to give input to power data processor 404. For example, a keyboard, keypad, light-pen, touch-screen, track-ball, or speech recognition unit, audio/video player, and the like could be used for input device 420. To output information, power data processor 404 may be in communication with an output device 422 via signal 426. The output device 422 can be virtually any device to give output from power data processor 404 to a user thereof, e.g., any conventional display screen, printer, set of speakers along with their respective interface cards, i.e., video card and sound card, etc. For example, output device 422 may be configured to output display 101 and/or sound via speakers 428 connected to I/O device 438 and output device 422 via signal 427. Although shown separately from the input device 420, output device 422 and input device 420 could be combined. For example, a display screen with an integrated touch-screen, a display with an integrated keyboard, or a speech recognition unit combined with a text speech converter could be used.

Power data processor 404 may be virtually any type of data processing system such as a laptop computer, desk top computer, mainframe, personal data assistant (PDA), and the like, that may be configured to perform embodiments of the present invention to advantage. In one embodiment, power data processor 404 includes a Central Processing Unit (CPU) 430, memory 432, and an input/output (I/O) device 438 in communication therewith via bus 118. Bus 118 may be configured to couple data from power sensors 110A to CPU 430, memory 432 and I/O device 438, for example. CPU 430 may be under the control of an operating system that may be disposed in memory 432. Virtually any operating system or portion thereof supporting the configuration functions disclosed herein may be used. Memory 432 is preferably a random access memory sufficiently large to hold the necessary programming and data structures of the present invention. While memory 432 is shown as a single entity, it should be understood that memory 432 may in fact comprise a plurality of modules, and that memory 432 may exist at multiple levels, from high speed registers and caches to lower speed but larger direct random access memory (DRAM) chips.

Illustratively, memory 432 may include a power data processing program 433 that, when executed on CPU 430, controls at least some data processing operations of power monitoring system 100. Power data processing program 433 may use any one of a number of different programming languages. For example, the program code can be written in PLC code (e.g., ladder logic), a higher-level language such as C, C++, Java, or a number of other languages. While power data processing program 433 may be a standalone program, it is contemplated that power data processing program 433 may be combined with other programs such as an operating system used with a computer processor such as computer 203.

In one embodiment, memory 432 may include power data 434. Power data 434 may utilize and be part of a database program such as Microsoft Access™, Oracle® database, and other data base programs configured to store data for processing thereof. Power data 434 may be processed by power data processor 404 to process information associated with power consumption of apparatus 150 (See FIG. 1 and FIG. 2). Power data 434 may include data associated with an electrical power supply via supply 101. For example, power data 434 may include apparatus power specifications (e.g., power and voltage), power consumption date, power efficiency data, power factor, and the like. Memory 432 may include apparatus data 435 including attributes associated with apparatus 150 such as model number, serial number, revision data, power specifications (e.g., current and voltage), installation date data, apparatus service data, and the like.

I/0 device 438 may be configured to output data on bus 118 in response to data received from input devices connected thereto such as computer 203 via signal 425 and input device 424 via signal 424. I/O device 438 may be configured to output data to output device 422 via signal 426 in response to data received from CPU 430 transmitted to I/O device 438 via bus 118. I/O device 438 may be configured to output data on bus 118 in response to apparatus specification data and other types of data accessed from external independent inventory databases 440, and/or found on the Internet 443 via signal 442. Such data from external independent inventory database 440 may include data indicative apparatus serial number, power ratings, efficiency ratings, modes of operation, and the like. Such data from external independent inventory database 440 may also include data associated with power usage from a utility company supplying power. For example, a utility company may provide data indicative of a monetary cost per kilowatts of power used per hour (kWH) or provide cost data associated with gas consumption.

In one embodiment, power processor 404 is configured to communicate with an intelligent apparatus 450 via power line 150 or wirelessly. In one configuration, intelligent apparatus 450 includes an apparatus 150 that includes a processor 451 that is configured to communicate with and provide operational control of apparatus 150 via signal bus 452. For example, intelligent apparatus 450 may be a refrigerator appliance having a computer based process controller coupled therewith or integral thereto.

In one operational configuration, such intelligent apparatus 450 receives commands from power monitoring system 100. Such commands may provide such intelligent apparatus 450 with a plurality of different operational configurations associated with cost of power usage. For example, consider the case where a utility company supplies power on a metered basis whereby a user thereof is charged for power based on when they use such power (i.e., power cost varies according to the time of day). Power monitoring system 100 may be configured to adjust operational parameters to set such intelligent apparatus 450 to a mode of operation that may reduce power consumption during peak cost periods and reconfigure such intelligent apparatus 450 to other modes during less costly periods. For example, consider the case where a smart air conditioning system normally operates to keep a temperature inside a building between 68° Fahrenheit (F.) to 72° F. During higher energy cost periods, power processor 404 may be configured to widen such temperature range to for example, 58° F. to 82° F. to save on energy usage. Thus, power monitoring system 100 may be configured to provide settings of such intelligent apparatus 450 whereby power usage is adjusted in accordance to a cost of power.

In another embodiment, power monitoring system 100 detects and processes power usage of an apparatus to determine a user utilization pattern that may be stored for example in memory 432. Such user utilization pattern may be used to adjust intelligent apparatus 450 to different modes of operation associated with such user utilization pattern. For example, consider the case of a smart refrigerator, power monitoring system 100 detects and stores power consumption data relative a user using one or more features of such smart refrigerator and then stores such power consumption data. Such power consumption data may then be processed by power monitoring system 100 to adjust operations of such smart refrigerator to be in a high user mode during peak usage times and a low usage mode for times when such smart refrigerator is used less and requires less power to operate.

For example, if a user opens a door of a smart refrigerator many times between the hours of five pm and eight pm, internal temperatures may fluctuate. Such smart refrigerator responds by rapidly increasing power usage to compensate for such temperature fluctuations. Power monitoring system 100 detects and processes such power usage and may be configured to set such smart refrigerator to modes that more rapidly adjust an internal temperature during such a high usage time. Conversely, power monitoring system 100 may be configured to set power operation of such smart refrigerator to low usage setting during low usage periods where such smart refrigerator may respond less rapidly to changes in internal temperature to maintain a desired internal temperature range.

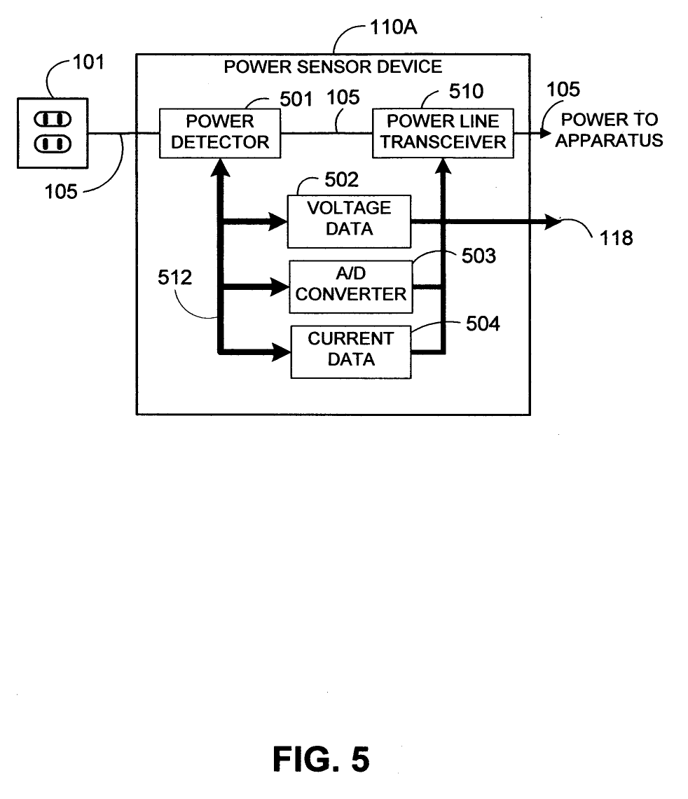

FIG. 5 is a high-level schematic of one embodiment of a power sensor 110A in accordance with embodiments of the invention. Power sensor 110A may be configured to detect power supplied from power source 106 (see FIG. 1) to apparatus 150. Power sensor 110A includes a power detector 501 electrically coupled via power signal 105 between power supply 101, such as an electrical outlet in a home, and a power line transceiver 510. Power signal 105 is coupled to apparatus 150 to supply electrical power thereto (See FIG. 1). Power detector 501 is configured to output data indicative of power flow from power supply 101 and apparatus 105 via signal 512. For example, power detector 501 may be configured as an electrical current and/or voltage power detector to detect a level of power being consumed by apparatus 150 and provide data indicative thereof to voltage data circuit, analog-to-digital (A/D) converter 503, and current data circuit 504.

In one embodiment, voltage data circuit 502 is configured to receive power data from power detector 501 and convert such power data into voltage data. Such voltage data may be coupled to power data processor 430 for processing thereof via bus 118. Current data circuit 504 is configured to receive power data from power detector 501 and convert such power data into current data. Such current data may be coupled to power data processor 430 for processing thereof via bus 118. A/D converter 503 is configured to convert analog power data signals from signal 512 to digital power data for use thereof by processor 430. Such digital power data may be transmitted to power data processor 430 for processing thereof via bus 118.

Power line transceiver 510 is configured to transmit one or more data associated with power consumption of apparatus 150 to power detector 501, voltage data circuit 502, A/D converter, and current data circuit 504, via signal bus 118 to power processor 430 for processing thereof. Power line transceiver 510 may also be configured to transmit voltage data, current data, and power data from voltage data circuit 502, A/D converter, and current data circuit 504, respectively via power signal 105 to a user thereof such as a utility company and power data processor 430. In one embodiment, power line transceiver 510 is configured to receive data and instructions from power source 106 for processing thereof. For example, a utility company may send configuration data to power line transceiver 510 via power line 105 to configure such power line transceiver 510 with respect to power source 106. Consider the case, where power source 106 is configured to communicate with power sensor apparatus 210A via one or more communication channels, an operator may transmit configuration protocols via power line 105 to power line transceiver 510 to configure power sensor apparatus 210A as desired.

In one embodiment, power line transceiver 510 is configured to communicate data associated with power measurements to a third party such as a utility commission for data processing. For example, a state operated utility commission may be interested in how much power is being consumed by various models of a given type of apparatus, power line transceiver 510 may be configured to transmit data to such third party via power line 105 and the Internet 443 for storage and analysis.

FIG. 6 is a high-level schematic of one embodiment of a power sensor 110B-N in accordance with embodiments of the invention. Power sensor apparatus 110B-N may be configured to detect power supplied from power source 106 (see FIG. 1) to apparatus 150. Power sensor 110B-N includes a power detector 501 electrically coupled via power signal 105 between power supply 101, such as an electrical outlet in a home, and a power line transceiver 610. Power signal 105 is coupled to apparatus 150 to supply electrical power thereto (See FIG. 1). Power detector 501 is configured to output data indicative of power flow from power supply 101 and apparatus 105 via signal 512. For example, power detector 501 may be configured as a power detector to detect a level of power being consumed by apparatus 150 and provide data indicative thereof to voltage data circuit 502, AID converter 503, and current data circuit 504.

In one embodiment, voltage data circuit 502 is configured to receive power data from power detector 501 and convert such power data into voltage data. Such voltage data may be coupled via signal 611 to a wireless transceiver 601. Wireless transceiver 601 is wirelessly coupled to access point 414 via antenna 412 and is configured to transmit such voltage data to power data processor 430 for processing thereof. Current data circuit 504 is configured to receive power data from power detector 501 and convert such power data into current data. Such current data may be coupled via signal 611 to wireless transceiver 601 to transmit such current data to power data processor 430 for processing thereof. A/D converter 503 is configured to convert analog power data signals from signal 512 to digital power data for use thereof by processor 430. Such digital power data may be coupled via signal 611 to a wireless transceiver 601 configured to transmit such power data to processor 430 for processing thereof.

Power line transceiver 610 is coupled to wireless transceiver 601 via bus 602. Power line transceiver 610 is configured to transmit one or more data associated with power consumption of apparatus 150 to power detector 501, voltage data circuit 502, A/D converter, and current data circuit 504, to power processor 430 for processing thereof via wireless transceiver 601. Power line transceiver 610 may also be configured to transmit voltage data, current data, and power data from voltage data circuit 502, A/D converter 503, and current data circuit 504, respectively, via power signal 105 to a user thereof such as a utility company providing power source 106.

In one embodiment, power line transceiver 610 is configured to receive data and instructions from power source 106 for processing thereof. For example, a utility company may transmit configuration data to power line transceiver 610 via power line 105 to configure such power line transceiver 610 with respect to power source 106. Consider the case, where power source 106 is configured to communicate with power sensor apparatus 210A via one or more communication channels, an administrator, for example, may transmit configuration protocols via power line 105 to power line transceiver 610 to configure power sensor apparatus 210B-N as desired by the administrator.

In one embodiment, power line transceiver 610 is configured to communicate data associated with power measurements to a third party such as a public utility commission. For example, a state operated public utility commission may be interested in how much power is being consumed by various configurations of a given type of appliance (e.g., apparatus 150), power line transceiver 610 may also be configured to transmit data to such third party via power line 105 and to the Internet 443 for analysis and storage.

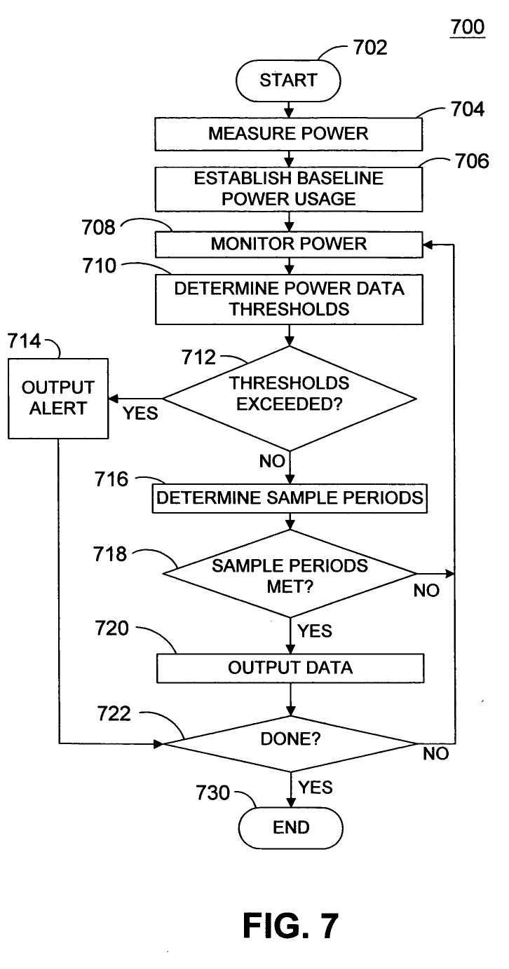

FIG. 7 is a high-level flow diagram of one embodiment of a method 700 to monitor power usage in accordance with embodiments of the invention. Method 700 may be entered into at 702 by an operation of power monitoring system 100, for example. At 704 power consumption is measured by for example, power sensor 110A,B-N. For example, a power sensor 110A,B-N may be configured to detect and measure an amount of power being consumed by an apparatus 150. At 706, a power consumption baseline is established. For example, method 700 searches one or more databases such as memory 432 to determine such base line power consumption. In one embodiment, such base line power consumption may be determined from a manufacture's specification and adjusted based on such an apparatus 150. For example, a brand new refrigerator may have a one thousand watt energy consumption rating when new and one thousand one hundred watts when five years old. A user thereof may establish a baseline. For example, a user may configure power monitoring system 100 to use power ratings of new equipment when establishing such a baseline to compare current operation to new operation. At 708, power consumption is monitored. At 710, method 700 determines a range of acceptable power consumption values about such power consumption base line. If at 712, a power consumption measured exceeds such range of acceptable power consumption values, then method 700 provides an alert indicative thereof at 714. However, if power consumption measured does not exceed such range of acceptable power consumption values, then method 700 proceeds to 716.

At 716, method 700 determines one or more sample periods. If at 718, such one or more sample periods are crossed, method 700 outputs data associated with power consumption to for example, display 101 and proceeds to 722. If however, at 718 such one or more sample periods are not crossed, then method 700 returns to 708. At 722, method 700 determines if such power monitoring is finished. If finished, then method 700 ends at 730. However, if at 722 such power monitoring is not finished, then method 700 returns to 708.

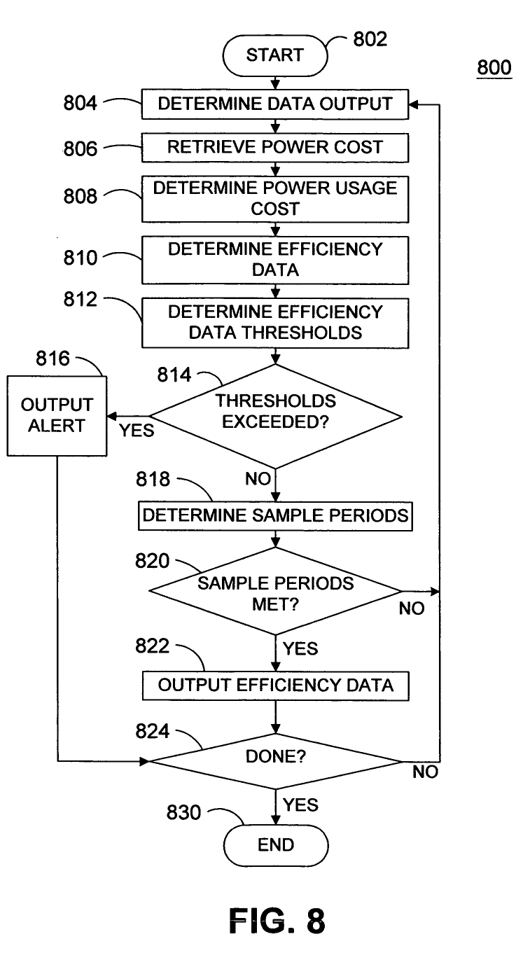

FIG. 8 is a high-level flow diagram of one embodiment of a method 800 to monitor power usage in accordance with embodiments of the invention. Method 800 may be entered into at 802, for example, by operation of power monitoring system 100. At 804, a power output data type is determined. For example, a data type may data associated with power consumption, power efficiency, power savings, current, voltage, gas consumption, and the like. At 806, a cost for power used is established. For example, method 700 searches one or more databases such as memory 432 to determine a cost for power consumption (e.g., $0.08 per kilowatt-hour, $0.01 per gas therm). At 808, a cost of power consumption is determined. At 810, method 800 determines how energy efficient an apparatus 150 associated therewith is (e.g., 97% energy efficient). At 812, a threshold range for such energy efficiency is established. If at 814, energy efficiency exceeds such threshold range for such energy efficiency, method proceeds to 816 and provides information thereof. If however, such energy efficiency is within such threshold range, then method 800 proceeds to 818 to determine one or more sample periods being used. At 820, if such sample periods exceed such one or more sample periods, then method 800 proceeds to 804. If however, such sample periods are crossed, method 800 outputs such efficiency data. If method 800 is finished at 824, then method 800 proceeds to 830 and ends. If however, if method 800 is not finished, at 824, then method 800 proceeds to 804.

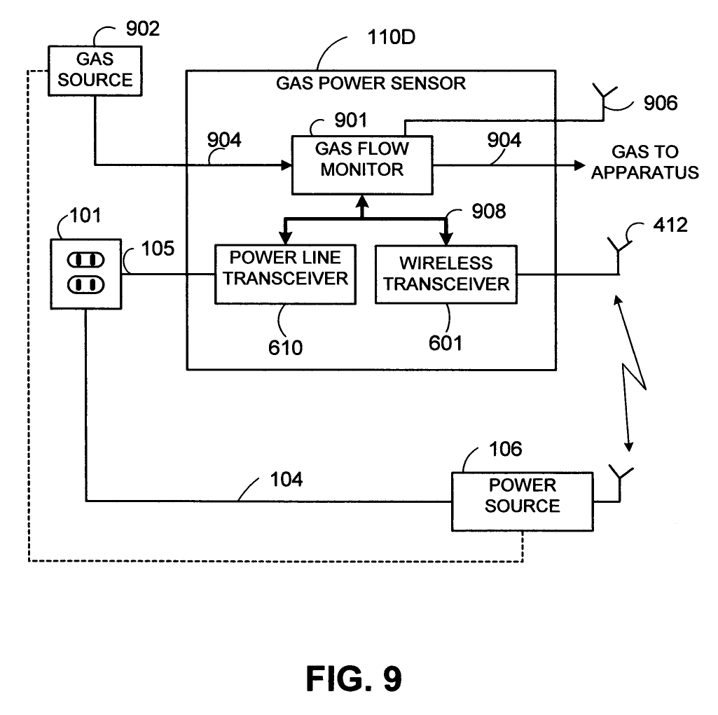

FIG. 9 is a high-level schematic of one embodiment of a gas power sensor 110D in accordance with embodiments of the invention. In one configuration, power sensor 110A and 110B may be configured as gas power sensor 110D. Gas power sensor 110D is configured to monitor the gas flow from a gas source 902 via gas line 904 to an apparatus 150 that consumes gas, such as natural gas. Gas power sensor 110D includes a gas flow monitor 901 coupled to the power line transceiver 610, and coupled to the wireless transceiver 601 via bus 908. Gas power sensor 110D also includes an antenna 906 configured to send and receive wireless signals to/from a wireless transmitter such as wireless access point 414.

Similar to power sensors 110A and 110B, gas power sensor 110D is configured to communicate with the apparatus 150 and/or a third party (e.g., a utility company power source 106 supplying the gas) via electrical connection 105 and power line 104 and/or wireless transceiver 601 (See FIGS. 1, 2 and 6). Gas power sensor 110D cooperates with power data processor 404 (See FIG. 4) to determine the actual power consumed by the apparatus 150 and the expected power consumed by the apparatus 150 from the gas flow.

The power data processor 404 calculates the difference between the power consumption expected based on the energy in the gas, i.e., joules, British thermal units (BTU), and the like. If the energy consumed associated with the gas flow exceeds the expected amount, then power data processor 404 alerts the user, for example, via display 101. In one embodiment, the difference between the gas delivered and the gas consumed may indicate a gas leak. Under such gas leak conditions, power data processor 404 may notify a user or third party such as the utility company 106 of the leak.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. An apparatus comprising:
a power sensor configured to monitor power consumed by a device;
a data storage device configured to store data associated with the power consumed;
an output device configured to output data associated with the power consumed; and
a processor, which when executing a power monitoring program, is configured to:
generate power consumption values associated with the power consumed;
determine if the power consumption values have exceeded a predetermined power consumption threshold,
output power consumption data indicative of any power consumption values that have exceeded the predetermined power consumption threshold;
generate power efficiency values associated with the power consumed;
determine if any of the power efficiency values have exceeded a predetermined power efficiency threshold;
output power efficiency data indicative of the power efficiency values that have exceeded the predetermined power efficiency threshold;
generate monetary cost values associated with the power consumed;
determine if any of the monetary cost values have exceeded a predetermined monetary cost threshold; and
provide monetary cost data indicative of any monetary cost values that have exceeded the predetermined monetary cost threshold.

2. The apparatus of claim 1, wherein the power sensor is configured to monitor an electrical power portion of the power consumed by the device.

3. The apparatus of claim 1, wherein the power sensor is configured to monitor a gas power portion of the power consumed by the device.

4. The apparatus of claim 1, wherein the power sensor comprises a power line transceiver configured to transmit at least one of the power consumption values, the power efficiency values, and the monetary cost values via an electrical power supply line to a user thereof.

5. The apparatus of claim 1, wherein the power sensor comprises a wireless transceiver configured to wirelessly transmit at least one of the power consumption values, the power efficiency values, and the monetary cost values to a user thereof.

6. The apparatus of claim 1, wherein the power sensor comprises one or more output signals indicative of at least one of an electrical power consumed and a gas power consumed by the device.

7. A system configured to monitor power consumption of a device, the system comprising:
a means for monitoring power consumption by a device;
a means for processing the power consumption, wherein the means for processing the power consumption is configured to:
analyze the power consumption of the device;
determine if the power consumption has exceeded a predefined range of power consumption;
determine, from the power consumption, a power efficiency of the device and determine if the power efficiency has exceed a predefined efficiency range associated with the device; and
output data associated the power consumption and the power efficiency to a user thereof.

8. The system of claim 7, wherein the means for monitoring power comprises a means for converting the power consumption to a data signal indicative thereof.

9. The system of claim 7, wherein the means for monitoring power comprises a means for generating power consumption data associated with the power consumption and transmitting the power consumption data to the power consumption processing means via an electrical power supply connection.

10. The system of claim 7, wherein the means for monitoring power comprises a magnetic field detector configured to associate electrical power consumption of the device with at least one electromagnetic field associated with the device.

11. The system of claim 7, wherein the means for monitoring power consumption comprises a means for inputting data associated with at least one of the power consumption, the efficiency rating, a time period, the predefined efficiency rating, and combinations thereof by a user.

12. The system of claim 7, wherein the power consumption comprises at least one of electrical power consumption, gas power consumption, and combinations thereof.

13. A method to measure the power consumption of an apparatus and provide data associated with the power consumption to a user thereof, the method comprising:
measuring an overall power consumption of the apparatus;
determining if the apparatus is operating within a predefined range of the overall power consumption, wherein if the overall power consumption of the apparatus exceeds a predefined range for the overall power consumption, then outputting overall power consumption error data indicative thereof;
determining if the apparatus is operating within a predefined power efficiency range, wherein if the power efficiency of the apparatus exceeds the predefined power efficiency range, then outputting power efficiency error data indicative thereof;
determining a power efficiency degradation rate of the apparatus;
determining a time value from the power efficiency degradation rate where the apparatus will exceed the predefined power efficiency range;
determining a monetary cost of the power consumption; and
outputting at least one of the overall power consumption, the predefined power efficiency range, the power efficiency degradation rate, the time value, and the monetary cost to the user.

14. The method of claim 13, wherein measuring the power consumption of the apparatus comprises monitoring at least one of a supply current, a supply voltage, and a magnetic field that correlates with the overall power consumption of the apparatus.

15. The method of claim 13, wherein determining if the apparatus is operating within the predefined range of the overall power consumption comprises determining a maximum power consumption of the apparatus.

16. The method of claim 13, wherein outputting the at least one of the overall power consumption comprises displaying two or more of the overall power consumption, the time value, power efficiency degradation rate, and the monetary cost to a user on a display device.

17. The method of claim 13, wherein determining if the apparatus is operating within the predefined range of the overall power efficiency comprises determining a maximum efficiency rating of the apparatus.

18. The method of claim 13, wherein outputting power efficiency error data comprises displaying the power efficiency error data on a display device.

19. The method of claim 13, wherein determining if the apparatus is operating within a predefined range of the power efficiency comprises comparing the power efficiency to a known power efficiency of the device.

20. The method of claim 13, wherein determining the time value comprises determining from the time value at least one of a date and a time when the apparatus is predicted to fall about below a predetermined minimum power efficiency of the device.
